(19) United States
(12) Patent Application Publication
(10) Pub. No.: US 2012/0311880 A1
(43) Pub. Date: Dec. 13, 2012

(54) MEASURING DEVICE SYSTEM

(76) Inventor: Douglas J. Doggett, Bondurant, IA (US)

(21) Appl. No.: 13/490,586

(22) Filed: Jun. 7, 2012

Related U.S. Application Data
(60) Provisional application No. 61/495,118, filed on Jun. 9, 2011.

(51) Int. Cl. B43L 7/10

(52) U.S. Cl. 33/452

(57) ABSTRACT

A measuring device system that provides the functions of a plurality of different measuring tools. The system has a triangular measurement member having printed indicia thereon and a first elongated slot extending along one side of the triangle and a second elongated slot extending along a second side of the triangle. An arcuate slot is connected to the second elongated slot. An elongated arm having a centrally located slot is adjustably connected to the first elongated slot and the second elongated slot or arcuate slot by connecting members. This system provides the advantage of performing a plurality of measurement functions, it replaces a plurality of tools, reduces the need for multiple tools and therefore improves efficiency.

### CROSS REFERENCE TO RELATED APPLICATION

This application claims the benefit of U.S. Provisional Application No. 61/495,118 filed Jun. 9, 2011.

### BACKGROUND OF THE INVENTION

This invention relates to tools. More specifically, this invention relates to an all in one measuring tool.

Measuring tools such as squares, rulers, saw guides, miter squares, rafter squares and the like have been around for years that assist workmen in accomplishing different tasks. Each of these different devices has its own unique purpose to assist the work person in a variety of different projects including tiling, roofing, decking, and the like.

A problem exists in that there is such an abundance of different tools for different applications that purchasing each individual tool is expensive. In addition, by having multiple different tools to keep track of, tools are easily lost and cumbersome to carry. Further, oftentimes, a person will get to a worksite and realize that one of the many tools they intended to pack was left behind forcing them to leave the worksite and go back to retrieve the tool causing delays and frustrations.

Thus, it is a primary object of the present invention to provide a measuring device system that improves upon the state of the art.

Another object of the present invention is to provide a measuring device that takes the place of several independent devices.

Yet another object of the present invention is to provide a measuring device that serves multiple needs.

Another object of the present invention is to provide a measuring device that is cost effective.

Yet another object of the present invention is to provide a measuring device that reduces the potential for lost or misplaced tools.

These and other objects, features, or advantages of the present invention will become apparent from the specification and claims.

### BRIEF SUMMARY OF THE INVENTION

A measuring device system that provides the functions of a plurality of different measuring tools. The system has, a triangular measurement member having printed indicia thereon and a first elongated slot extending along one side of the triangle and a second elongated slot extending along a second side of the triangle. An arcuate slot is connected to the second elongated slot. An elongated arm having a centrally located slot is adjustably connected to the first elongated slot and the second elongated slot or arcuate slot by connecting members. This system provides the advantage of performing a plurality of measurement functions, it replaces a plurality of tools, reduces the need for multiple tools and therefore improves efficiency.

### BRIEF DESCRIPTION OF THE DRAWINGS

FIG. 1 is a perspective view of a first embodiment of a measuring device.

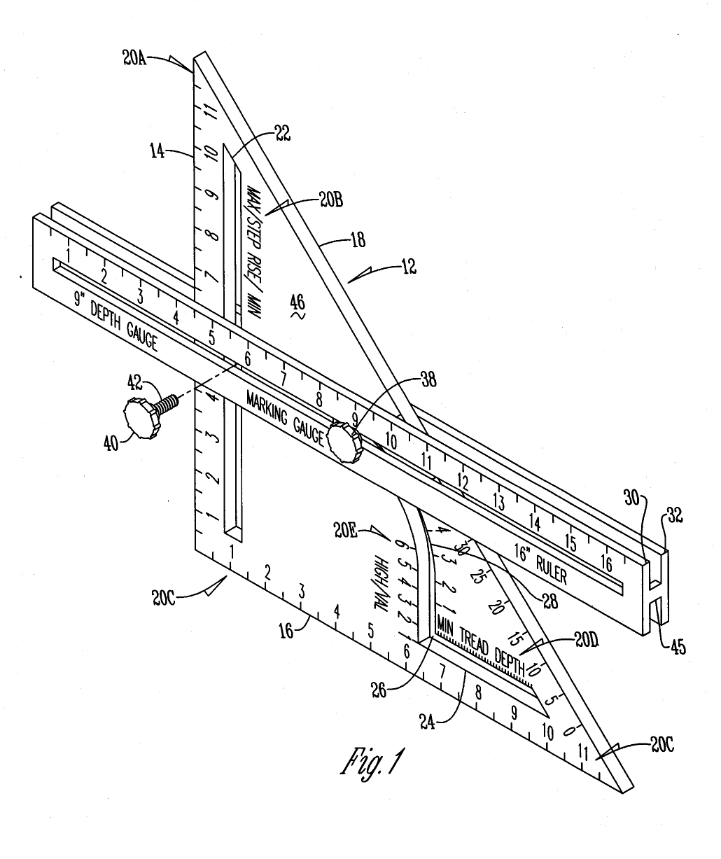

FIG. 2 is a perspective view of a second embodiment of a measuring device.

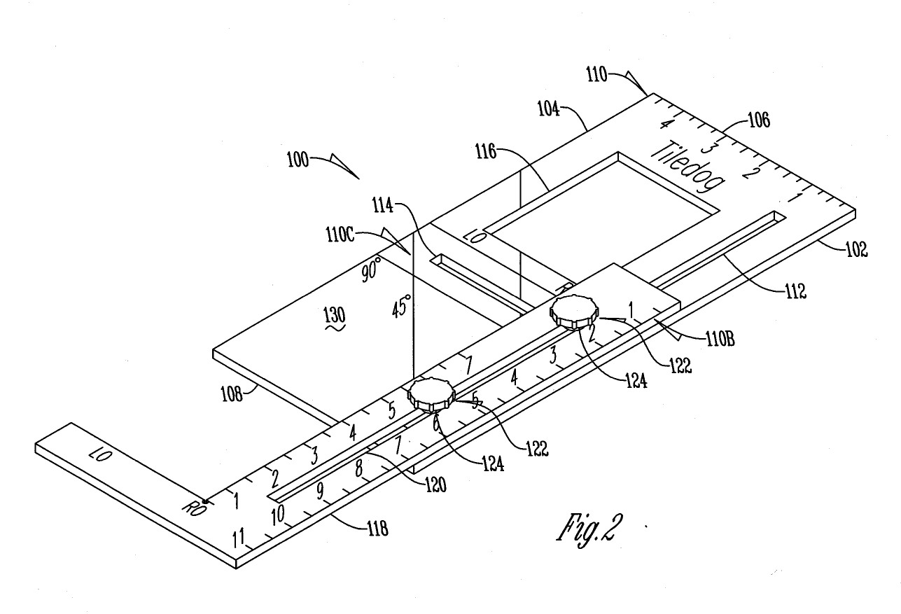

### DETAILED DESCRIPTION OF THE PREFERRED EMBODIMENT

The figures show a measuring device system 10 that provides the functions of a plurality of different measuring tools. The system 10 has a triangular measurement member 12 that in a preferred embodiment is made from a metal plate. The triangular member 12 generally is a right triangle with first measuring side 14 and second measuring side 16 with a hypotenuse side 18 extending therebetween. Each of the first measuring side 14 and second measuring side 16 has printed indicia 20 thereon at predetermined locations to present measurements along each side. Similarly, the hypotenuse side 18 has printed indicia 20 thereon that provide additional predetermined measurements corresponding to different angles. The term printed indicia 20 is not meant to be limiting and can include any form of visible indicia including painted text, stickers, indented text, raised text, holes, grooves, inscribing, or the like or any combination thereof. In one embodiment the first measuring side 16 and second measuring side 18 are the same length. Alternatively, the triangular measurement member 12 is a right triangle with one side at 9 inches or alternatively a rectangle.

Disposed through the triangular measurement member 12 and disposed adjacent to the first measuring side 14 is a first elongated slot 22 that extends longitudinally the length of the entire first measuring side 14. Preferably the first elongated slot 22 extends in parallel spaced alignment with the first measuring side 14 in straight, un-curved, and square fashion. Adjacent the first elongated slot 22 is printed indicia 20. This includes primary printed indicia 20A positioned between the first measuring side 14 and the first elongated slot 22 which indicates length among other information. This also includes secondary printed indicia 20B, which is positioned adjacent first elongated slot 22 on the side opposite from first measuring side 14 which indicates maximum and minimum step rise among other information.

Like the first elongated slot, disposed through the triangular measurement member 12 is a second elongated slot 24 which is positioned adjacent the second measuring side 16 of the triangle measurement member 12. Preferably the second elongated slot 24 extends in parallel spaced alignment with the second measuring side 16 in straight, un-curved, and square fashion. In a preferred arrangement, the second elongated slot 24 only extends longitudinally partially along the second measurement side 16 a distance before terminating at its terminating point 26. Alternatively, second elongated slot 24 extends the entire length of second measuring side 16 like first elongated slot 22. At its termination point 26, second elongated slot 24 converges at a pivot point with an arcuate slot 28. Arcuate slot 28 extends from the termination point 26 of second elongated slot 24 adjacent the second measuring side 16 toward and along the hypotenuse side 18. Preferably, arcuate slot 28 curves in arcuate fashion with its convex side towards the hypotenuse side 18 and its concave side towards first measuring side 14; alternatively it curves in the opposite direction.

Adjacent the second elongated slot 24 is printed indicia 20. This includes primary printed indicia 20C positioned between the second measuring side 16 and the second elongated slot 24 which indicates length, among other information. This also includes secondary printed indicia 20D which is positioned adjacent second elongated slot 24 on the side opposite from second measuring side 16 regarding minimum tread and maximum tread regarding a depth measurement, among other information. Meanwhile, adjacent either side of the arcuate slot 28 is printed indicia 20E at predetermined measurement locations that determine roof pitch, among other information.

First elongated arm 30 and second elongated arm 32 are movably attached to the triangle measurement member 12. Preferably, first elongated arm 30 and second elongated arm 32 are identical to one another. Both the first elongated arm 30 and second elongated arm 32 have an elongated arm slot 34 extending the length of the arm 30, 32 in straight and square parallel spaced alignment with the arm's exterior edges. Preferably arm slots 34 run the length of the elongated arm 30, 32 in a centered position. Printed indicia 20F is positioned on either side adjacent the arm slot 34 at predetermined locations representing measurements, among other information. Each of the first and second arms 30, 32 are movably connected to the triangle measurement member 12 via first connection member 36 and second connection member 38 that have adjustable heads 40 secured to elongated stems 42 with threaded portions that mesh with nut elements 44 positioned opposite adjustable heads 40.

When put together the first elongated arm 30 is placed on a top surface 46 of the triangle measurement member 12 and the second elongated arm 32 is placed on a bottom surface 48 of the triangle member 12. Preferably, nut portions 44 do not protrude past the surface of the second elongated arm 32 so that the bottom surface 48 is flat, flush and smooth and devoid of any protrusion. The stem 42 of the first connection member 36 is then disposed through the first elongated slot 22 and then through the elongated arm slot 30 of the second elongated arm 32 and then nut portion 44 is connected to the end of elongated stem 42 opposite adjustable head 40 to lock the pieces together. Similarly, stem 42 of the second connection member 38 is then disposed through the second elongated slot 24 or through the arcuate slot 28 and then through the elongated arm slot 30 of the second elongated arm 32 and then nut portion 44 is connected to the end of elongated stem 42 opposite adjustable head 40 to lock the pieces together. The nut elements 44 and/or adjustable heads 40 are twisted in a first direction to adjustably compress together the first and second arms 30, 32 against the triangle measurement member 12, or alternatively are twisted in an opposite second direction to loosen the arms 30, 32.

In operation, the first elongated arm 30 can be used as a ruler, marking gauge, or depth gauge as a result of sliding the elongated arm 30 laterally along the triangle member 12 along the first and second elongated slots 22, 24. When in place the first and second connection members 36, 38 can then be tightened to prevent movement between the triangle measurement member 12 and the first and second elongated arms 30, 32.

Alternatively, the second connection member 38 can be placed in the pivot point/termination point 26 between the second elongated slot 24 of the second measuring side 16 and the arcuate slot 28 at which point it is tightened. Then the first connection member 36 can move within the first elongated slot 22 of the first measuring side 14 to provide multiple angles to present a stair gauge.

Alternatively, the second connection member 38 can be placed in the arcuate slot 28 adjacent the second side 16 and secured in place while the first connection member 36 is in the first elongated slot 22 to present a roof pitch gauge that can present different roof pitches.

One skilled in the art will also appreciate that the triangle measurement member 12 itself can operate as a miter square and a rafter square. Meanwhile, the second elongated arm 32 can be utilized as a 90 degree to 50 degree saw guide. Thus, a plurality of functions and tools are incorporated into this single system.

In an alternative embodiment a rectangular member 100 having first elongated side 102 and a second elongated side 104 in parallel spaced alignment and shorter parallel top and bottom sides 106, 108 connect the first and second elongated sides 102, 104 to form the rectangle 100. Along the top short side 106 printed indicia 110A with predetermined lengths is presented to act as a ruler. A first elongated slot 112 adjacent and extending longitudinally the length of an elongated side 102, 104 is presented with a secondary slot 114 running perpendicular to the first elongated slot 112 and extending therefrom at an intersection between the first elongated slot 112 and the second elongated slot 114 that occurs preferably at a right angle.

The rectangular member 100 also has a rectangular opening 116 disposed therethrough of size and shape of an electrical outlet. An L-shaped arm 118 is presented having an elongated slot 120 extending longitudinally therein with marked indicia 110B at predetermined locations on either side of the slot 120. First and second connection members 122 having heads 124, stems 126 and nut elements 128 as discussed above are disposed through the slot 120 of the L-shaped member 118 and the elongated slot 112, 114 of the rectangular member 100 to connect the L-shaped member 118 to the rectangular member 100. As a result of the rectangular member 100 having a T-shaped slotting 112, 114 the L-shaped member can provide 360 degrees of positioning and measurement.

Similar to the triangle measurement member 10 embodiment, in operation the first and second connection members 122 move within the elongated slot 120 of the L-shaped member 118, the elongated slot 112 of the first side 102 of the rectangular member 100 and the perpendicular slot 114 in order to move the L-shaped member 118 in relation to the rectangular member 100. Specifically, when the first and second connection members 122 are both within the first elongated slot 112 the L-shaped member 118 acts as a caliper providing needed measurements between the L-shaped arm 118 and the bottom side 108 (or top side 106).

Alternatively, when a first connection member 122 is in the first elongated slot 112 and the second connection member 122 is in the perpendicular slot 114, an angled measurement is provided wherein an indicia 110C is on the top surface 130 of rectangular member 100 indicating where a 45 degree angle (or any other angle) is presented. When the first and second connecting members are both within the perpendicular slot 114, again indicia is on the rectangular member 100 on either side of the L-shaped member 118 indicating that a 90 degree angle is presented and the system may be used as a traditional miter square.

In addition, as a result of the rectangular opening 116 the rectangular member can be placed around an outlet so that additional measurements can be presented when doing jobs such as tiling where such obstructions are presented. Thus, one does not have to remove the outlet cover in order to present proper measuring.

Thus presented are multiple systems that utilize a combination of slots and movable connection members in order to provide multiple functions of a plurality of different measurement tools. Thus, only a single tool has to be brought to a worksite eliminating the chance that a tool is forgotten and left behind. In addition, only a single system has to be purchased thus saving cost for a work person and additionally because tools do not have to be switched out, time is also saved. Thus, the present device has overcome the deficiencies in the art.

What is claimed is:

1. A measuring device, comprising:
a triangular measurement member having top side, a bottom side, a first measurement side, a second measurement side and a hypotenuse side;
a first elongated slot is positioned adjacent the first measurement side;
a second elongated slot is positioned adjacent the second measurement side;
an arcuate slot is positioned in the triangular measurement member;
a first elongated arm is connected to the triangular measurement member; and
wherein the first elongated arm is adjustably connected to the triangular measurement member through a first connection member which passes through one of the first elongated slot, the second elongated slot or the arcuate slot.

2. The measuring device of claim 1 further comprising wherein the triangular measuring member is a right triangle.

3. The measuring device of claim 1 further comprising wherein the first connection member passes through the first elongated arm and the first elongated slot and a second connection member passes through the first elongated arm and the second elongated slot.

4. The measuring device of claim 1 further comprising wherein the first elongated arm has an elongated slot through which the first connection member passes.

5. The measuring device of claim 1 further comprising wherein the first elongated slot extends approximately the entire length of the first measurement side.

6. The measuring device of claim 1 further comprising wherein the second elongated slot extends only a portion of the length of the second measurement side.

7. The measuring device of claim 1 further comprising wherein the second elongated slot and the arcuate slot are connected.

8. The measuring device of claim 1 further comprising a second elongated arm positioned opposite the first elongated arm.

9. The measuring device of claim 1 further comprising wherein the triangular measurement member has measuring indicia positioned on its top side that provide both angle measurements and distance measurements.

10. A measuring device, comprising:
a rectangular measurement member having top surface, a first elongated side and second elongated side in parallel spaced alignment, and a top side and bottom side in parallel spaced alignment;
a first elongated slot extending a length of the rectangular measurement member;
a second elongated slot extending in perpendicular alignment to the first elongated slot;
a rectangular opening positioned in the rectangular measurement member;
an L-shaped arm connected to the rectangular measurement member by a first connection member; and
wherein the L-shaped arm is adjustably connected to the rectangular measurement member through a first connection member which passes through one of the first elongated slot or the second elongated.

11. The measuring device of claim 10 further comprising wherein the rectangular opening is of the size and shape of a conventional electrical outlet.

12. The measuring device of claim 10 further comprising wherein the L-shaped member is connected to the rectangular measurement member by the first connection member and a second connection member positioned in the first elongated slot or the second elongated slot.

13. The measuring device of claim 10 further comprising wherein the first elongated slot and second elongated slot are connected.

14. The measuring device of claim 10 further comprising wherein when the L-shaped member is extended, the L-shape member acts as a caliper providing measurements.

15. The measuring device of claim 10 further comprising measuring indicia positioned on the top surface of the rectangular measurement member that provide both angle measurements and distance measurements.
